(19) United States
(12) Patent Application Publication
(10) Pub. No.: US 2004/0252481 A1
(43) Pub. Date: Dec. 16, 2004

(54) Backlight unit and liquid crystal display device having the same

(76) Inventor: Seung-hwan Moon, Gyeonggi-do (KR)

Correspondence Address: GRAY CARY WARE & FREIDENRICH LLP, 2000 UNIVERSITY AVENUE, E. PALO ALTO, CA, 94303-2248, US

(21) Appl. No.: 10/798,548

(22) Filed: Mar. 10, 2004

(30) Foreign Application Priority Data
Jun. 10, 2003 (KR) 2003-37228

(51) Int. Cl. G01D 11/28

(52) U.S. Cl. 362/31

(57) ABSTRACT

A backlight unit according to an embodiment of the present invention comprises a lamp and an inverter circuit unit. The lamp unit includes first and second lamp groups and first to fourth electrode connecting means. Here, the first and second lamp groups are constructed in such a manner that a plurality of lamps are allocated into two groups. The first lamp group is connected to the first and third electrode connecting means, while the second lamp group is connected to the second and fourth electrode connecting means. At this time, the first and second electrode connecting means are disposed on the left side, and the third and fourth electrode connecting means are disposed on the right side. The respective lamps constituting the first and second lamp groups are alternately disposed at a predetermined interval. The inverter circuit unit includes first and second inverters. The first inverter applies an AC voltage for driving the first lamp group to the first and third electrode connecting means, and the second inverter applies an AC voltage for driving the second lamp group to the second and fourth electrode connecting means. Thus, the first and second lamp groups are driven in parallel by the first and second inverters, respectively. Even though luminance difference occurs between the first and second lamp groups due to deviations in the properties of the first and second inverters, the problem of the prior art wherein luminance difference occurs between lamp blocks can be solved by alternately disposing the respective lamps constituting the first and second lamp groups.

### BACKGROUND OF THE INVENTION

This application claims the priority of Korean Patent Application No. 10-2003-0037228 filed on Jun. 10, 2003 in the Korean Intellectual Property Office, the disclosure of which is incorporated herein in its entirety by reference.

### 1. FIELD OF INVENTION

The present invention relates to a backlight unit and a liquid crystal display device having the same.

### 2. DESCRIPTION OF THE PRIOR ART

Generally, a liquid crystal display (LCD) device comprises a liquid crystal panel, a converter for driving the liquid crystal panel, a backlight unit, an inverter for driving the backlight unit, and the like.

Since the liquid crystal panel of the liquid crystal display device is not self-luminous, it cannot be used in dark places. Thus, a variety of lamps are used as a backlight unit for uniformly irradiating light onto the entire liquid crystal panel from the back of the liquid crystal panel.

Backlight units are classified into direct type backlight units and edge type backlight units according to the layout structure of the lamps used. Direct type backlight units directly illuminate the entire liquid crystal panel by disposing a plurality of lamps below the liquid crystal panel, thereby improving luminance and enlarging the luminous area as compared with edge type backlight units.

Lamps used for backlight units include cold cathode fluorescent lamps (CCFLs), external electrode fluorescent lamps (EEFLs), and the like. The EEFLs can be easily driven in parallel since they have external electrodes.

Recently, as the sizes of liquid crystal display devices widely used for TVs increase, the lengths and the number of such lamps have increased.

Inverters with high driving power capacity should be provided to drive such lamps. There is a limitation on the driving of lamps for a large liquid crystal display device by a single inverter.

Heretofore, to solve this problem, there has been used a method by which lamps are allocated into two or more groups and inverters for driving the lamp groups are disposed thereto, respectively.

For example, in a direct type liquid crystal display device requiring forty (40) lamps as shown in FIG. 5, the lamps are allocated into two groups such that twenty (20) lamps are disposed at the upper portion while the other twenty (20) lamps are disposed at the lower portion, which are driven in parallel by two inverters 1 and 2, respectively.

However, there is a problem of this method in that since there are deviations in the properties of the inverters, luminance difference occurs between the upper and lower lamp groups, resulting in a phenomenon that causes the liquid crystal display device to be unpleasant to the eye.

### SUMMARY OF THE INVENTION

The present invention is conceived to solve the aforementioned problem. An object of the present invention to provide a backlight unit having uniform luminance by disposing lamps in such a manner that luminance difference does not occur between lamp blocks in a lamp unit which is divided into two or more groups, and a liquid crystal display device having the backlight unit.

According to an aspect of the present invention for achieving the object, there is provided a backlight unit, comprising first and second lamp groups including a plurality of lamps, respectively; first and third electrode connecting means electrically connected to both electrodes of each of the lamps constituting the first lamp group; and second and fourth electrode connecting means electrically connected to both electrodes of each of the lamps constituting the second lamp group. The respective lamps constituting the first and second lamp groups are alternately arranged.

The backlight unit may further comprise a first inverter for driving the first lamp group, and a second inverter for driving the second lamp group.

Here, a phase difference in voltages output from the first and second inverters may be less than 90 degrees.

According to another aspect of the present invention, there is provided a backlight unit, comprising two or more lamp groups constructed in such a manner that a plurality of lamps are allocated into two or more groups; and a plurality of electrode connecting means electrically connected to both electrodes of each of the lamps constituting the two or more lamp groups. The respective lamps constituting the two or more lamp groups are alternately arranged.

The backlight unit may further comprise two or more inverters for driving the two or more lamp groups.

Here, a phase difference in voltages output from the two or more inverters may be less than 90 degrees.

Further, each of the lamps may have external electrodes.

According to a further aspect of the present invention, there is provided a liquid crystal display device, comprising a liquid crystal module including a liquid crystal panel, a gate-driving unit for sequentially applying gate-on signals to gate lines of the liquid crystal panel, and a data-driving unit for applying data signals to all data lines of the liquid crystal panel; and a backlight unit for irradiating a predetermined amount of light to the liquid crystal panel. The backlight unit comprises first and second lamp groups including a plurality of lamps, respectively, first and third electrode connecting means electrically connected to both electrodes of each of the lamps constituting the first lamp group, and second and fourth electrode connecting means electrically connected to both electrodes of each of the lamps constituting the second lamp group. The respective lamps constituting the first and second lamp groups are alternately arranged.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram illustrating a liquid crystal display device according to an embodiment of the present invention;

FIG. 2 is a view showing a lamp with external electrodes;

FIG. 3 is a view showing the structure of a backlight unit according to an embodiment of the present invention; and

FIG. 4 is a view explaining an embodiment of the present invention in which lamps constituting first and second lamp groups are connected to respective electrode connecting means.

FIG. 5 is a view showing the structure of a backlight unit according to a conventional art.

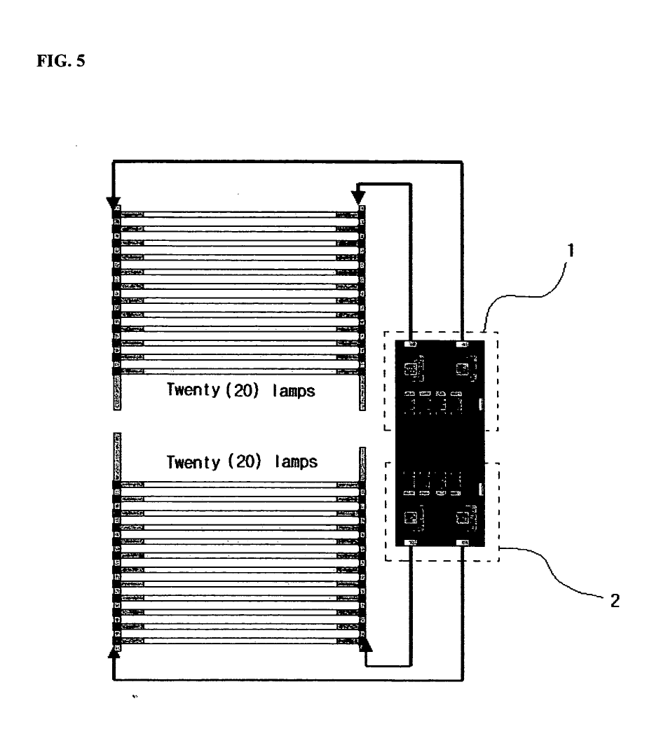

### DETAILED DESCRIPTION OF THE INVENTION

Hereinafter, preferred embodiments of the present invention will be described with reference to the accompanying drawings.

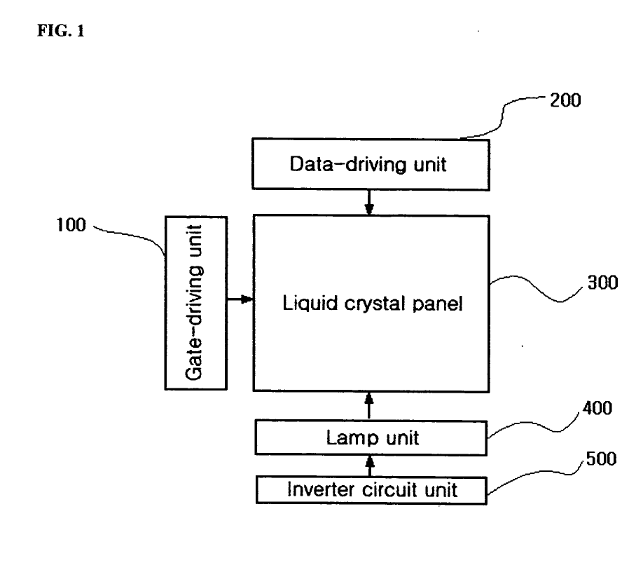

FIG. 1 is a block diagram illustrating a liquid crystal display device according to an embodiment of the present invention.

As shown in FIG. 1, the liquid crystal display device according to the embodiment of the present invention comprises a liquid crystal module including a gate-driving unit 100, a data-driving unit 200 and a liquid crystal panel 300; a lamp unit 400; and an inverter circuit unit 500 for driving the lamp unit 400.

The gate-driving unit 100 receives a gate clock and a gate-on enable signal from a timing controller (not shown), and sequentially applies gate-on signals, which is synchronized with the two signals, to gate lines of the liquid crystal panel 300.

The data-driving unit 200 is driven by a signal output from the timing controller (not shown), and applies data signals, which is synchronized with the driving of the gate-driving unit 100, to all data lines of the liquid crystal panel 300.

The liquid crystal panel 300 consists of a plurality of pixel regions in the form of a matrix in which the plurality of gate lines intersect the plurality of data lines. The liquid crystal panel receives the gate-on signal and data voltage output from the gate-driving unit 100 and the data-driving unit 200 to display images of respective frames.

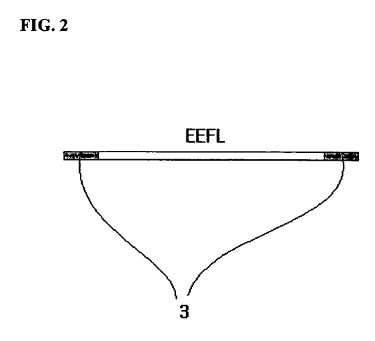

The lamp unit 400 serves to provide a predetermined amount of light to a rear surface of the liquid crystal panel. Although a variety of lamps can be employed in the lamp unit, it is preferred that the lamp unit have a direct type backlight structure using EEFLs with external electrodes 3 at opposite ends thereof, as shown in FIG. 2. Here, the direct type backlight structure includes a plurality of lamps disposed at the rear of the liquid crystal panel and a diffuser sheet over the lamps to provide a predetermined amount of light with uniform luminance to the liquid crystal panel.

The inverter circuit unit 500 converts a DC voltage from an external power supply unit into an AC voltage suitable for driving the lamp unit 400, and outputs the AC voltage.

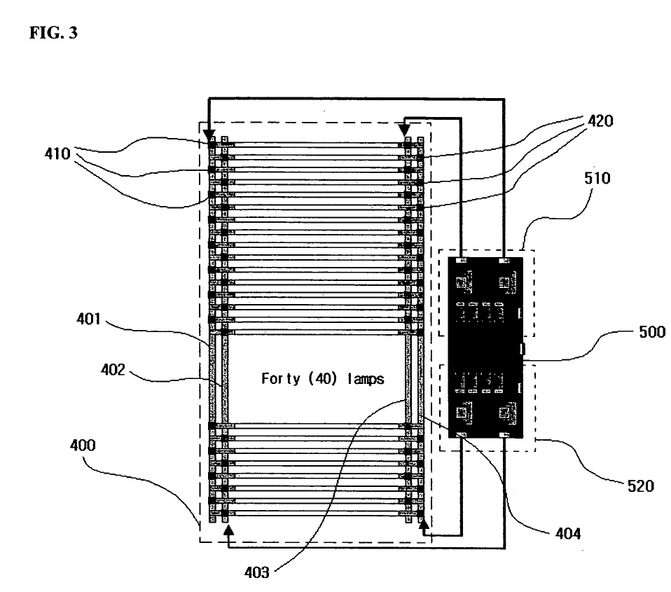

Next, the lamp unit 400 and the inverter circuit unit 500 constituting a backlight unit of the present invention will be described in detail with reference to FIG. 3. FIG. 3 is a view showing the structure of the backlight unit according to an embodiment of the present invention.

As shown in FIG. 3, the backlight unit according to the embodiment of the present invention comprises the lamp unit 400 and the inverter circuit unit 500.

The lamp unit 400 includes first and second lamp groups 410 and 420, and first to fourth electrode connecting means 401, 402, 403 and 404.

Here, the first and second lamp groups 410 and 420 consist of a plurality of lamps divided into two groups. The first lamp group 410 is connected to the first and third electrode connecting means 401 and 403, and the second lamp group 420 is connected to the second and fourth electrode connecting means 402 and 404.

At this time, the first and second electrode connecting means 401 and 402 are disposed on the left side, and the third and fourth electrode connecting means 403 and 404 are disposed on the right side. The respective lamps constituting the first and second lamp groups 410 and 420 are alternately disposed at a predetermined interval.

In other words, both electrodes of each of the lamps constituting the first lamp group 410 are electrically connected to the first and third electrode connecting means 401 and 403, while both electrodes of each of the lamps constituting the second lamp group 420 are electrically connected to the second and the fourth electrode connecting means 402 and 404.

At this time, one of the lamps constituting the first lamp group 410 is disposed at the top of the lamp unit 400, and one of the lamps constituting the second lamp group 420 is disposed at the next position. Thus, the respective lamps constituting the first and second lamp groups 410 and 420 are alternately disposed.

Here, it is preferred that the lamps be EEFLs, which are easily driven in parallel due to the external electrodes 3 thereof. The inverter circuit unit 500 includes first and second inverters 510 and 520.

The first inverter 510 applies an AC voltage for driving the first lamp group 410 to the first and third electrode connecting means 401 and 403, and the second inverter 520 applies an AC voltage for driving the second lamp group 420 to the second and fourth electrode connecting means 402 and 404.

Thus, the first and second lamp groups 410 and 420 are driven in parallel by the first and second inverters 510 and 520, respectively. Even though luminance difference occurs between the first and second lamp groups 410 and 420 due to deviations in the properties of the first and second inverters 510 and 520, the problem of the prior art wherein luminance difference occurs between lamp blocks can be solved by alternately disposing the respective lamps constituting the first and second lamp groups 410 and 420. Further, light emitting from the first and second lamp groups 410 and 420 is sufficiently scattered by a diffuser sheet (not shown) positioned over the lamps, thereby providing a backlight having uniform luminance.

Meanwhile, it is preferred that the AC voltages output from the first and second inverters 510 and 520 be in phase or out of phase by less than 90 degrees.

If the phase difference is 90 degrees or more, voltages having different polarities are applied between the first and second electrode connecting means 401 and 402 and between the third and fourth electrode connecting means 403 and 404, and thus, leakage currents may be produced between the first and second electrode connecting means 401 and 402 and between the third and fourth electrode connecting means 403 and 404.

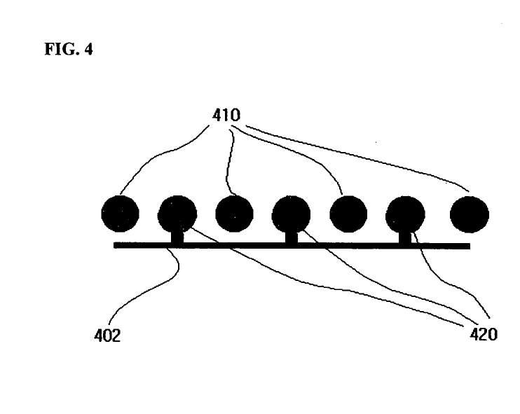

FIG. 4 is a view explaining an embodiment of the present invention in which the lamps constituting the first and second lamp groups 410 and 420 are connected to the respective electrode connecting means.

In such a structure in which the respective lamps constituting the first and second lamp groups 410 and 420 are alternately disposed, the lamps of the first and second lamp groups 410 and 420 are connected to the respective electrode connecting means such that the first and second lamp groups can be placed on the same plane as shown in FIG. 4.

Referring to the second electrode connecting means 402 by way of example, the second electrode connecting means 402 underlies the alternate lamps constituting the first and second lamp groups 410 and 420. Electrodes of the lamps constituting the first lamp group 410 are not connected to the connecting means 402, whereas those of the lamps constituting the second lamp group 420 are connected to the connecting means 402.

Although the lamps have been allocated into two groups by way of example in this embodiment of the present invention, the lamps may be allocated into two or more groups by disposing a plurality of electrode connecting means in the same manner so far as the lengths of the external electrodes for the lamps are acceptable.

Thus, since the direct type backlight unit according to the present invention has alternately disposed lamps constituting two or more lamp groups, the backlight unit can solve the problems of the prior art wherein luminance difference occurs between lamp blocks of the lamp groups due to deviations in the properties of the inverters for driving the lamp groups of lamps, and provide uniform luminance.

According to the backlight of the present invention, the respective lamps allocated into two or more groups are alternately disposed, thereby solving the problem of the prior art wherein the luminance difference occurs between lamp blocks of the lamp groups, and supplying a predetermined amount of light with uniform luminance to the liquid crystal panel.

Although the present invention has been described in connection with the embodiments thereof with reference to the accompanying drawings, it is not limited thereto. Those skilled in the art can make various modifications thereto without departing from the technical spirit and scope of the present invention.

What is claimed is:

1. A backlight unit, comprising:
first and second lamp groups including a plurality of lamps, respectively;
first and third electrode connecting means electrically connected to both electrodes of each of the lamps constituting the first lamp group; and
second and fourth electrode connecting means electrically connected to both electrodes of each of the lamps constituting the second lamp group,
wherein the respective lamps constituting the first and second lamp groups are alternately arranged.

2. The backlight unit as claimed in claim 1, further comprising:
a first inverter for driving the first lamp group, and
a second inverter for driving the second lamp group.

3. The backlight unit as claimed in claim 2, wherein a phase difference in voltages output from the first and second inverters is less than 90 degrees.

4. A backlight unit, comprising:
two or more lamp groups constructed in such a manner that a plurality of lamps are allocated into two or more groups; and
a plurality of electrode connecting means electrically connected to both electrodes of each of the lamps constituting the two or more lamp groups,
wherein the respective lamps constituting the two or more lamp groups are alternately arranged.

5. The backlight unit as claimed in claim 4, further comprising:
two or more inverters for driving the two or more lamp groups.

6. The backlight unit as claimed in claim 5, wherein a phase difference in voltages output from the two or more inverters is less than 90 degrees.

7. The backlight unit as claimed in claim 1 or 4, wherein each of the lamps has external electrodes.

8. A liquid crystal display device, comprising:
a liquid crystal module including a liquid crystal panel, a gate-driving unit for sequentially applying a gate-on signal to gate lines of the liquid crystal panel, and a data-driving unit for applying a data signal to all data lines of the liquid crystal panel; and
a backlight unit for irradiating a predetermined amount of light to the liquid crystal panel,
wherein the backlight unit comprises first and second lamp groups including a plurality of lamps, respectively, first and third electrode connecting means electrically connected to both electrodes of each of the lamps constituting the first lamp group, and second and fourth electrode connecting means electrically connected to both electrodes of each of the lamps constituting the second lamp group, the respective lamps constituting the first and second lamp groups being alternately arranged.

9. The device as claimed in claim 8, further comprising:
two or more inverters for driving the two or more lamp groups.

10. The device as claimed in claim 9, wherein a phase difference in voltages output from the two or more inverters is less than 90 degrees.
